(19) United States
(12) Patent Application Publication
(10) Pub. No.: US 2021/0088370 A1
(43) Pub. Date: Mar. 25, 2021

(54) VALVE WITH TRANSDUCER AND FLUID OR MILK MEASURING

(71) Applicant: Checkmate Environmental Solutions, Inc., Wilmington, DE (US)

(72) Inventor: Vernon Clifford Coxhead, 32 Opunake (NZ)

(21) Appl. No.: 17/031,311

(22) Filed: Sep. 24, 2020

Related U.S. Application Data
(60) Provisional application No. 62/905,048, filed on Sep. 24, 2019.

(51) Int. Cl. G01F 23/16; F16K 1/22

(52) U.S. Cl. CPC G01F 23/16; F16K 1/22

(57) ABSTRACT

Apparatuses for measuring a fluid, each apparatus including a (e.g., butterfly) valve in communication with the fluid and a (e.g., pressure) transducer that measures (e.g., volume of) the fluid, where the transducer is mounted on the valve. A valve for controlling a fluid, the valve having a transducer mounted on the valve. An apparatus for storing and measuring liquid, for instance, milk, the apparatus including a tank that holds the liquid or milk, a valve connected to the tank that controls flow from the tank, and a pressure transducer mounted on the valve, where the pressure transducer measures pressure of the liquid or milk in the tank; and the pressure in the tank is used to calculate quantity of the liquid or milk in the tank. The transducer may be mounted at, or parallel or concentric to, the axis of rotation of the valve, and the axis may be vertical. The transducer may be mounted on the bottom of the valve.

### CROSS REFERENCE TO RELATED APPLICATIONS

This application claims the priority of U.S. Provisional Patent Application No. 62/905,048 entitled “VALVE WITH TRANSDUCER AND FLUID OR MILK MEASURING,” filed Sep. 24, 2019, the contents of which are hereby incorporated by reference.

### FIELD OF THE INVENTION

Various embodiments of this invention concern apparatuses for measuring a fluid, valves for controlling a fluid, or both. A number of embodiments include a transducer mounted on a valve. Certain embodiments can be used for measuring or storing a liquid (e.g., milk), for example.

### BACKGROUND OF THE INVENTION

Valves have been used for controlling various fluids and different transducers have been used for measuring different aspects of fluids. Further, pressure transducers have been used for measuring pressure and pressure measurements have been used to calculate the quantity or volume of a fluid, for instance, in a tank. Still further, liquid (e.g., milk) has been stored in tanks and valves have been connected to tanks and used to control flow of the liquid (e.g., milk) from the tank. Even further, pressure transducers have been used to measure the volume of liquid (e.g., milk) in a tank, but such pressure transducers have typically been mounted on the tank. This has required welding a fitting to the tank. In addition, pressure transducers have typically not been at the lowest point on the tank. As a result, prior art pressure transducers have not been effective at measuring the volume of the liquid (e.g., milk) in the tank when the tank is nearly empty.

For these and other reasons, room for improvement exists over the prior art in apparatuses, methods, and systems for measuring a fluid. Further, room for improvement exists over the prior art in valves for controlling a fluid, as examples, including in valves that measure the fluid or include a transducer. Further, needs or potential areas for benefit exist for valves that include a transducer or apparatuses that include a transducer mounted on a valve. Still further, room for improvement exists over the prior art in apparatuses, methods, and systems for measuring or storing liquid (e.g., milk), or both. Potential for benefit or improvement exists in these and other areas that may be apparent to a person of skill in the art having studied this document.

### SUMMARY OF THE INVENTION

Various embodiments are or include systems and methods, for example, apparatuses for measuring a fluid, valves for controlling a fluid, or both, or methods related thereto. Many embodiments include a transducer mounted on a valve. Some embodiments can be used for measuring or storing a liquid (e.g., milk), as examples, or both measuring and storing. Different embodiments include valves, for example, for controlling various fluids, transducers, for instance, for measuring at least one aspect of a fluids, or both a valve and a transducer. Further, some embodiments include a pressure transducer, for example, for measuring pressure. Still further, in some embodiments, pressure measurements are used to calculate the quantity or volume of a fluid, for instance, in a tank. Further still, in some embodiments, liquid (e.g., milk) is stored in a tank and a valve is connected to the tank and used, for example, to control flow of the liquid (e.g., milk) from the tank. Even further, in some embodiments, (e.g., pressure) transducers are used to measure the volume of liquid (e.g., milk), for instance, in a tank. Even further still, in particular embodiments, the (e.g., pressure) transducer is at or near (i.e., in elevation) the lowest point, for example, on the tank. As a result, certain embodiments are effective at measuring (e.g., the volume, for instance, of liquid (e.g., milk), for example, in the tank), for instance, when the tank is nearly empty.

Objects and potential for benefit exist in these areas individually and in various combinations, including in apparatuses, methods, and systems for measuring a fluid, in valves for controlling a fluid, and in valves that measure the fluid or include a transducer or in apparatuses that include a transducer mounted on a valve. Still further, objects and potential for benefit exist in apparatuses, methods, and systems for measuring or storing liquid (e.g., milk), for example, or both measuring and storing. Objects and potential for benefit or improvement exist in these and other areas that may be apparent to a person of skill in the art having studied this document. In addition, various other embodiments of the invention are also described herein, and other benefits of certain embodiments are described herein or may be apparent to a person of skill in this area of technology.

### BRIEF DESCRIPTION OF THE DRAWINGS

FIG. 1 is an exploded isometric view of an example of a valve with a transducer illustrating an example of an apparatus for measuring a fluid, a valve for controlling a fluid, a transducer mounted on a valve, and at least part of an apparatus for measuring or storing liquid (e.g., milk), as examples;

FIG. 2 is an exploded side view of the valve and transducer of FIG. 1;

FIG. 3 is an exploded front view of the valve and transducer of FIG. 1;

FIG. 4 is an exploded view of a valve disc;

FIG. 5 is a sketch of an example of a valve with a transducer;

FIG. 6 is a photograph of an example of a valve with a transducer where the valve is connected to a tank, illustrating, among other things, examples of an apparatus for measuring a fluid and an apparatus for storing and measuring liquid (e.g., milk);

FIG. 7 is a photograph of an example of a valve with a transducer;

FIG. 8 is a photograph looking inside the valve shown in FIG. 7, illustrating, among other things, the valve disc;

FIG. 9 is an isometric view of another example of a valve with a transducer illustrating another example of an apparatus for measuring a fluid, a valve for controlling a fluid, a transducer mounted on a valve, and at least part of an apparatus for measuring or storing liquid (e.g., milk), as examples;

FIG. 10 is a front view of the valve with a transducer of FIG. 9;

FIG. 11 is a top view of the example of a valve with a transducer of FIG. 9;

FIG. 12 is an isometric view of another example of a valve with a transducer illustrating another example of an apparatus for measuring a fluid, a valve for controlling a fluid, a transducer mounted on a valve, and at least part of an apparatus for measuring or storing liquid (e.g., milk), as examples, this view showing the valve disc open;

FIG. 13 is another isometric view of the valve with a transducer of FIG. 12, this view showing the valve disc closed; and

FIG. 14 is an assembly isometric view of the valve and transducer of FIGS. 1-3.

The drawings provided herewith illustrate, among other things, examples of certain aspects of particular embodiments. Other embodiments may differ. Some embodiments include a portion of the components or acts illustrated. Further, various embodiments may include aspects shown in one or more of the drawings, described in the specification (including the claims), known in the art, or a combination thereof, as examples.

### DETAILED DESCRIPTION OF THE PREFERRED EMBODIMENTS

This patent application describes, among other things, examples of certain embodiments, and certain aspects thereof. Other embodiments may differ from the particular examples described in detail herein. Various embodiments are or concern apparatuses for measuring a fluid, valves 10 for controlling a fluid, a valve 10 with a transducer 12, a transducer mounted on a valve 10, apparatuses for measuring or storing liquid (e.g., milk), or a combination thereof, as examples.

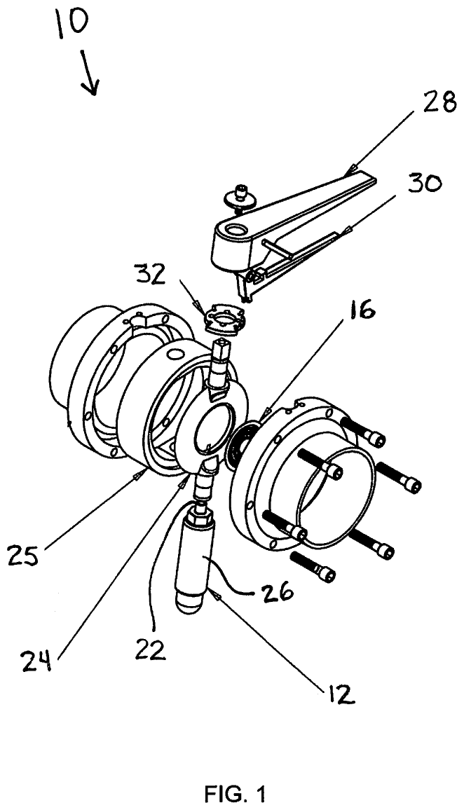

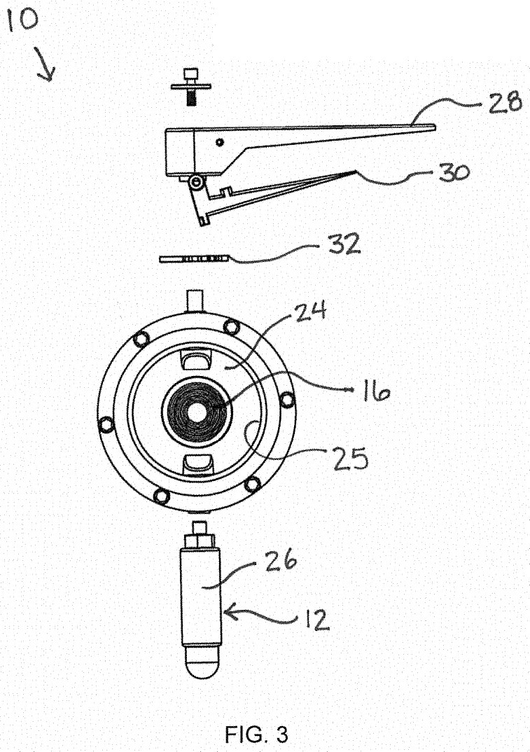

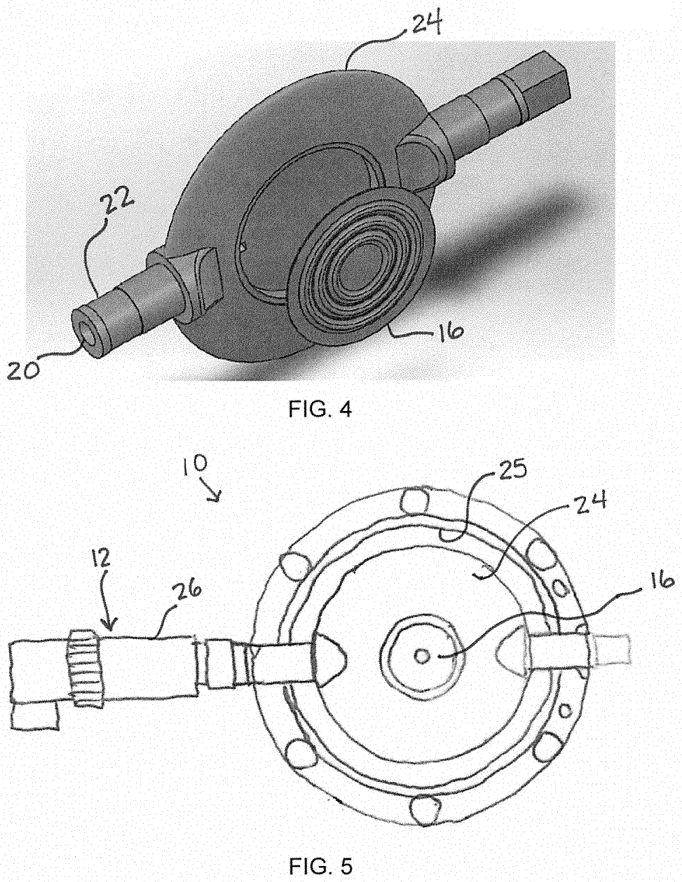

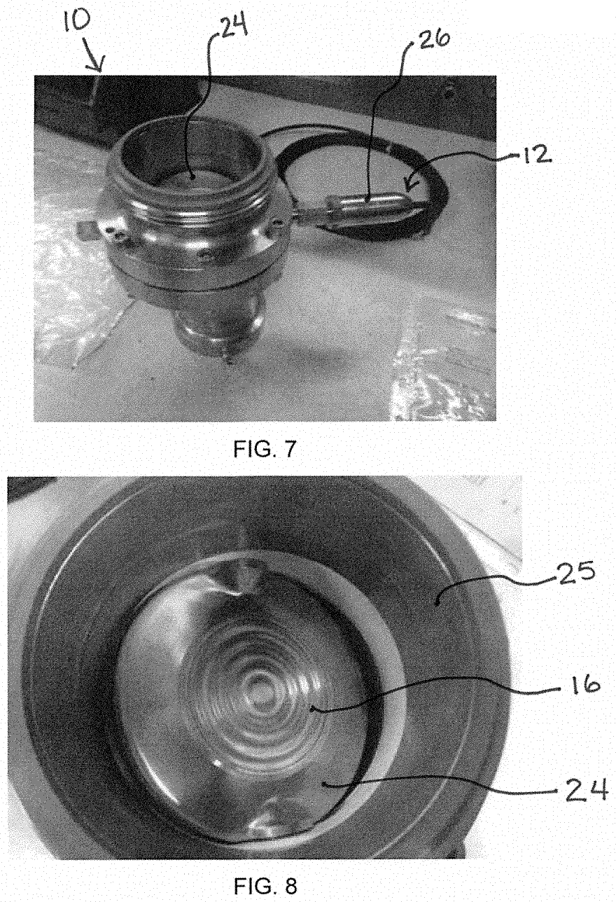

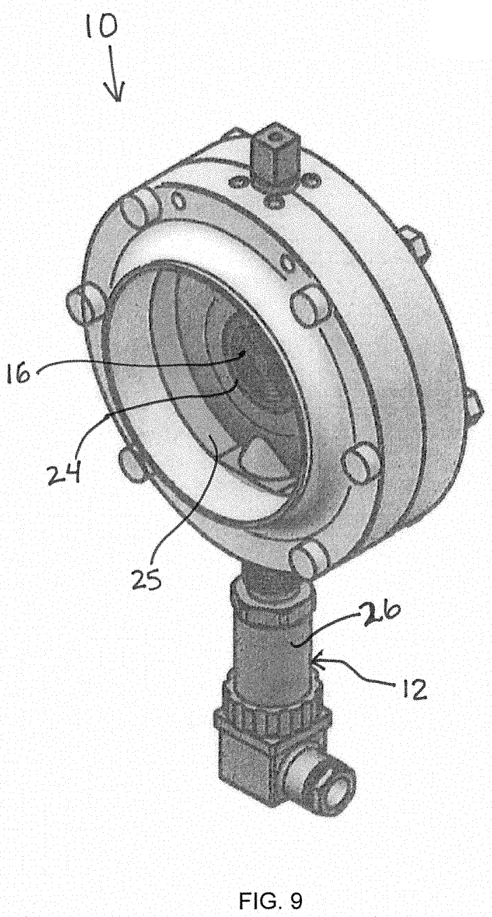

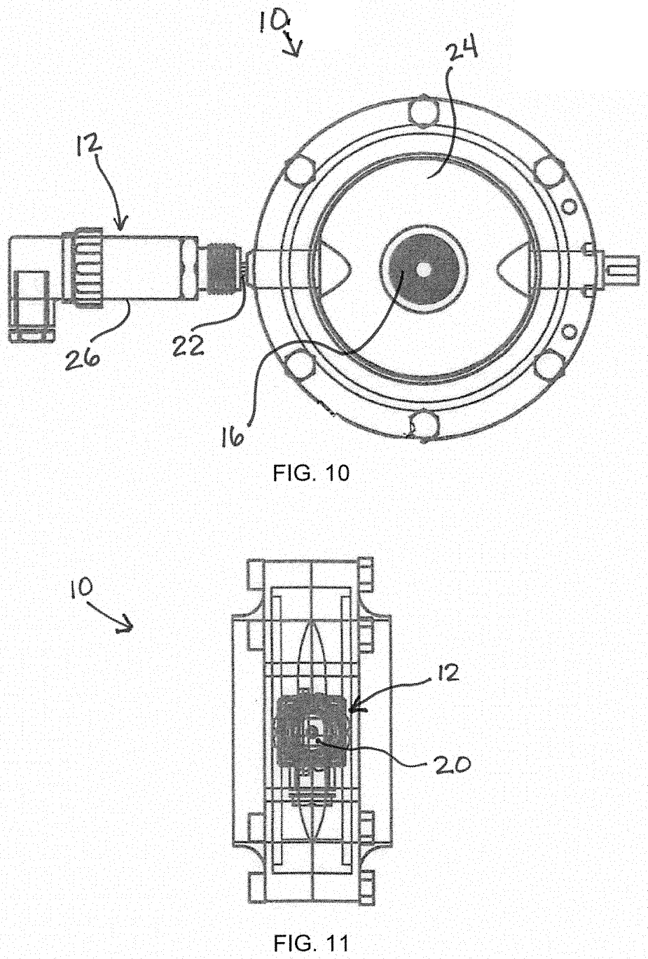

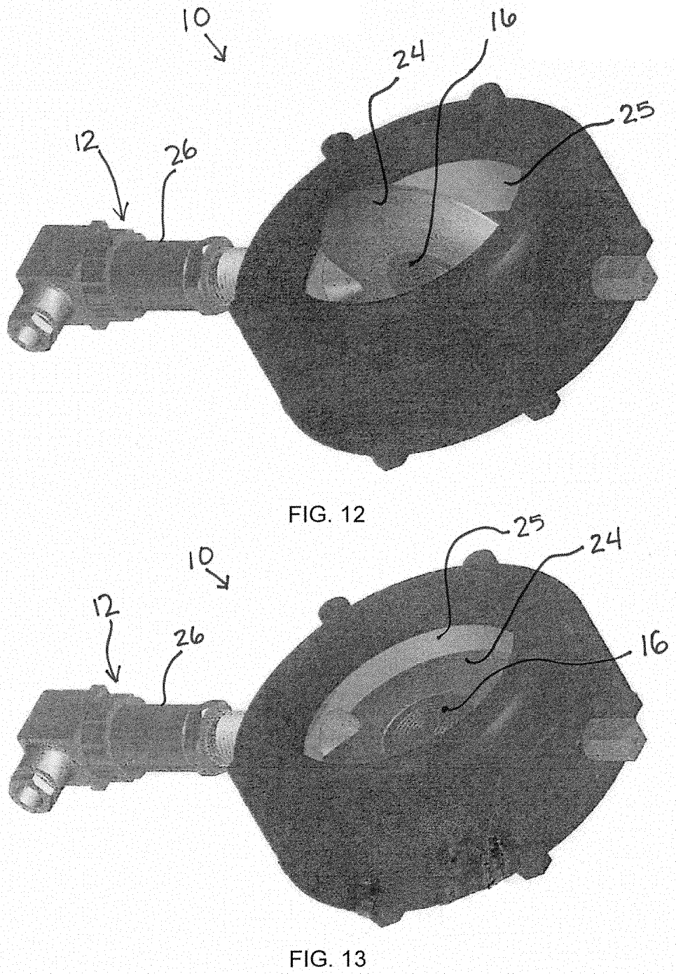

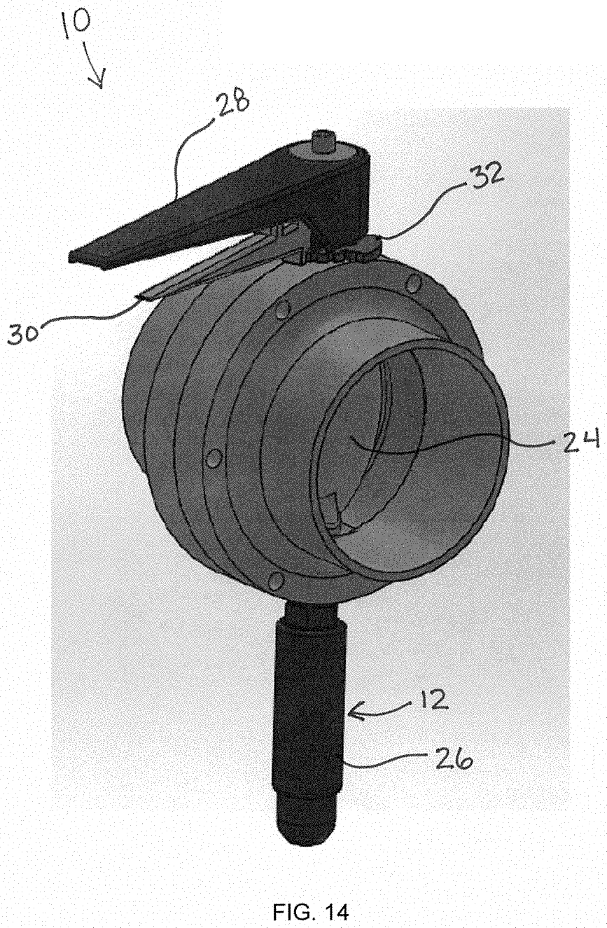

Some embodiments are or include an apparatus, for example, for measuring a fluid. In a number of embodiments, for instance, the apparatus includes a valve 10, for example, in communication with the fluid. In this context, as used herein, “in communication with” a fluid means in contact with the fluid when the valve 10 is being used with the fluid, for example, to control flow of the fluid. Examples of valves 10 are shown in FIGS. 1-3 and 5-14. Further, various embodiments include a transducer 12, for instance, that measures the fluid. Further still, in various embodiments, the transducer 12 is mounted on the valve 10. Examples of transducers 12 are shown in FIGS. 1-3, 5-7, 9, 10, and 12-14. Examples of transducers 12 mounted on valves 10 are shown in FIGS. 5-7, 9, 10, and 12-14. In a number of embodiments, the transducer 12 is attached or connected to the valve 10 with threads, at least one weld, or both, as examples.

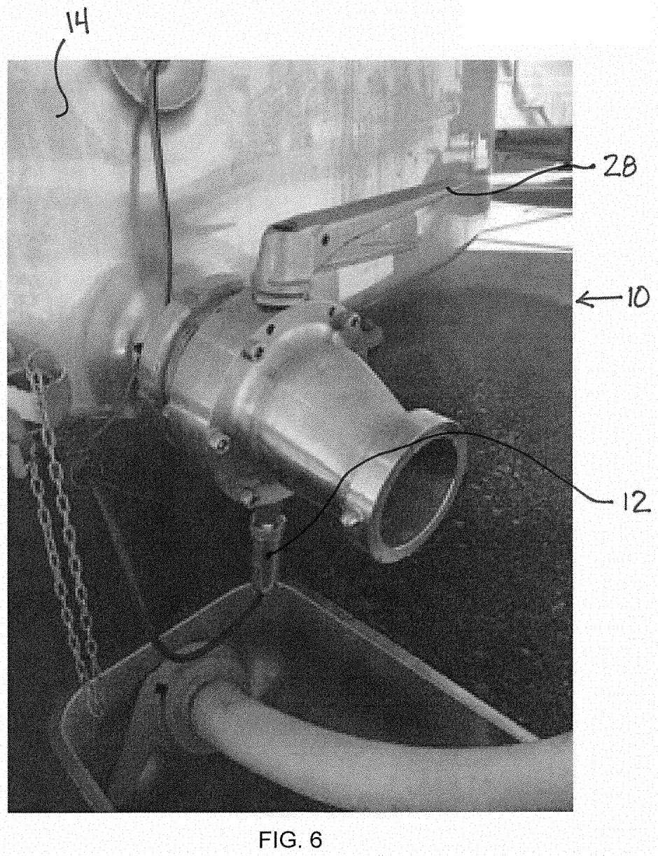

Moreover, in some embodiments, the apparatus (e.g., further) includes a tank 14. An embodiment having a tank 14 is shown in FIG. 6. Further, in some embodiments, the fluid (e.g., liquid, for instance, milk) is in the tank 14. Still further, in a number of embodiments, the valve 10 is attached to the tank 14 (e.g., as shown in FIG. 6). Even further, in various embodiments, the valve 10 controls flow (e.g., discharge) of the fluid (e.g., liquid, for instance, milk) from the tank 14. The embodiment shown in FIG. 6 is an example. In this example, when the valve 10 is closed, the fluid (e.g., liquid, for instance, milk), is retained in the tank 14, and when the valve 10 is open, the fluid (e.g., liquid, for instance, milk), is allowed to flow from the tank 14 by gravity. This is an example of “control” of flow, as used herein. Moreover, is, the valve 10 can be partially opened to control rate of flow of the fluid from the tank 14. This is another example of “control” of flow, as used herein. Even further still, in some embodiments, the transducer 12 is used to measure quantity (e.g., mass, volume, or both) of the fluid, for instance, in the tank 14. In a number of embodiments, for instance, the transducer 12 is used to measure a parameter of the fluid, such as pressure, which is then used to determine or calculate quantity (e.g., mass, volume, or both) of the fluid, for instance, in the tank 14. As used herein, this is an example of a transducer 12 being used to measure quantity of the fluid in the tank 14.

Various embodiments are or include a valve 10, for example, for controlling a fluid. Further, in a number of embodiments, the valve 10 includes a transducer 12, for instance, mounted on the valve 10. As mentioned, examples of transducers 12 mounted on valves 10 are shown in FIGS. 5-7, 9, 10, and 12-14. Further, in various embodiments, the transducer 12 is a pressure transducer. Further still, in a number of embodiments, the transducer 12 measures pressure of the fluid. Still further, in a number of embodiments, the transducer 12 is used to measure quantity of the fluid. For example, in various embodiments, the transducer 12 is used to measure volume of the fluid, for instance, when the valve 10 is closed. Further still, in some embodiments, the transducer 12 is used to measure volume of the fluid when the valve 10 is open. Moreover, in particular embodiments, the transducer 12 is used to measure volume of the fluid while the fluid is being drained or pumped out of the tank 14, or both. For example, in certain embodiments, the transducer 12 is used to measure volume of the fluid when the valve 10 is partially open or at least partially open. Even further, in a number of embodiments, the fluid is a liquid. Even further still, in particular embodiments, the fluid is milk.

Still further, some embodiments are or include an apparatus for storing or measuring (e.g., liquid, for instance, milk), or both storing and measuring (e.g., liquid, for instance, milk). Further, in a number of embodiments, the apparatus includes a tank 14, for example, that holds the liquid, for instance, milk, a valve 10, for instance, connected to the tank 14, or both. Further still, in various embodiments, the valve 10 controls flow (e.g., of the liquid, for instance, milk), for instance, from the tank 14. Even further, various embodiments include a (e.g., pressure) transducer 12, for example, mounted on the valve 10. Even further still, in a number of embodiments, the (e.g., pressure) transducer 12 measures pressure (e.g., of the liquid, for instance, milk) in the tank 14 and the pressure (e.g., of the liquid, for instance, milk) in the tank 14 is used to calculate quantity (e.g., of the liquid, for example, milk, for instance, volume) in the tank 14. FIG. 6 illustrates an example.

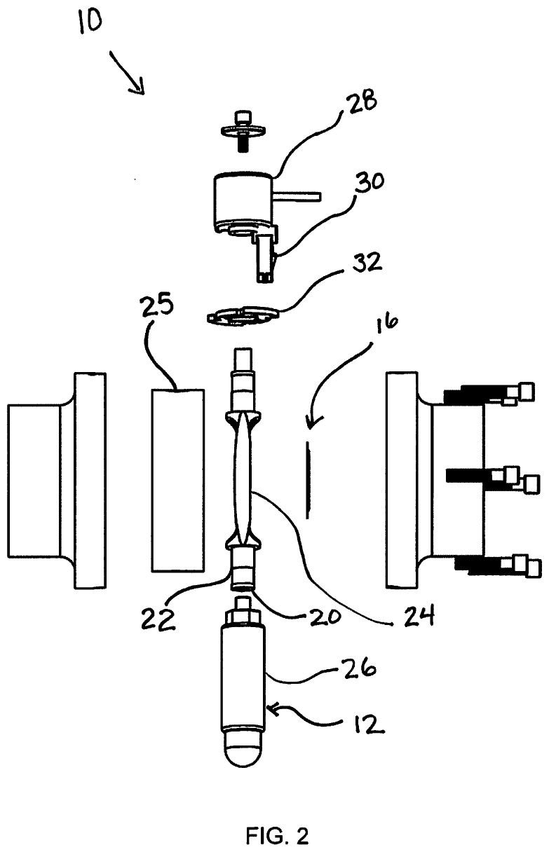

In a number of embodiments, the valve 10 is a butterfly valve. Examples are shown in FIGS. 1-14. Further, in various embodiments, the valve 10 has an axis of rotation and the transducer 12 is mounted at the axis of rotation of the valve 10. Examples are shown in FIGS. 1-3, 5-7, 9, 10, and 12-14. Still further, in some embodiments, the transducer 12 is parallel to the axis of rotation of the valve 10. Again, examples are shown in FIGS. 1-3, 5-7, 9, 10, and 12-14. Further still, in particular embodiments, the transducer 12 is concentric with the axis of rotation of the valve 10. Again, examples are shown in FIGS. 1-3, 5-7, 9, 10, and 12-14. Even further, in certain embodiments, the axis of rotation is vertical or substantially vertical. As used herein, vertical means vertical to within 10 degrees, and substantially vertical means vertical to within 25 degrees. Examples of valves 10 with vertical axes of rotation are shown in FIGS. 2, 3, 9, and 14. Further, the axis of rotation is at least substantially vertical in FIG. 1. Even further still, in various embodiments, the valve 10 has a bottom and the transducer 12 is mounted on the bottom of the valve 10. Examples are shown in FIGS. 1-3, 9, and 14.

In some embodiments, the apparatus or valve 10 includes a pressure plate 16. Further, in particular embodiments, a cavity is machined into the valve 10 and the cavity contains the pressure plate 16. Still further, in certain embodiments, the pressure plate 16 and the valve 10 are connected, for example, under vacuum. Further still, in some embodiments, the pressure plate 16 and the transducer 12 are connected, for instance, under vacuum. Even further, in some embodiments, the apparatus or valve 10 includes a (e.g., food-grade) fluid. Even further still, in particular embodiments, the pressure plate 16 and the transducer 12 are connected, for instance, with the (e.g., food-grade) fluid. Moreover, in some embodiments, the apparatus or valve 10 includes a channel 20, for example, in the valve 10. In certain embodiments, for instance, the pressure plate 16 and the transducer 12 are connected, for example, by the channel 20. Further, in various embodiments, the channel 20 transmits pressure, for instance, from the pressure plate 16 to the transducer 12. Still further, in particular embodiments, the channel 20 is machined (e.g., drilled), for example, into the valve 10. Further still, in certain embodiments, the channel 20 extends through a component, for example, of the valve 10. Examples of a component of a valve 10 include a valve stem, a valve shaft 22, or a valve disc 24. An example of a valve disc 24 is shown in FIG. 4. In FIG. 4, the channel 20 is visible at the left side of the view. Valve disc 24 may engage valve seal 25.

In various embodiments, the apparatus or valve 10 includes a PLC, for example, that reads the transducer 12. In a number of embodiments, for instance, the PLC calculates a quantity, for example, of the fluid, for instance, from a reading of the transducer. Still further, some embodiments include a display, for example, that displays the quantity of the fluid, for instance, from the PLC. In particular embodiments, for instance, the quantity displayed is a volume, for example, of the fluid (e.g., liquid, for instance, milk) in the tank 14.

In multiple embodiments, a pressure transducer tap is made up of a transducer pressure sensing unit 26 and a pressure plate 16. In certain embodiments, the pressure plate 16 is machined into the (e.g., butterfly) valve 10 and then the two are connected (e.g., under vacuum), for instance, using a food-grade fluid to transmit the pressure. In a number of embodiments, because the transducer 12 is mounted into the tap, it gives the most accurate measure, as it is at the lowest point of the vessel (e.g., tank 14). Further, in a number of embodiments, the integrity of the vessel is maintained, it is an easy installation, no welding is required, or a combination thereof. Various embodiments mount a pressure transducer 12 on a valve 10. Still further, in particular embodiments, where or how the pressure transducer 12 is mounted on the valve 10 may be important, for example, to measure a volume of liquid, for instance, milk or, in some embodiments, for another purpose.

In a number of embodiments, mounting the (e.g., pressure) transducer 12 in the valve 10, as opposed to mounting it somewhere else, results in an accurate measurement, is easy to install, or both. Further, in various embodiments, the (e.g., pressure) transducer 12 is read, for example, using a 4-20 milliamp PLC or transmitting modem, as examples. Still further, in different embodiments, the tank 14 can be either mobile or fixed. Further still, in various embodiments, the measurement from the (e.g., pressure) transducer 12 is converted, for example, to volume (e.g., of liquid, for instance, milk). In some embodiments, there is a calibration process, for example, for each type of tank 14. This may be dependent on the type of tank 14 and a mathematical calculation may be involved. Even further, in some embodiments, the valve 10 has a handle 28, for instance, opposite the transducer 12. Examples are shown in FIGS. 1-3, 6, and 14. In a number of embodiments, for instance, the handle 28 is on the top of the valve 10 and the transducer 12 is on the bottom of the valve 10, for example, on the axis or shaft 22. Handle 28 may be provided in combination with locking lever 30 and positioning plate 32.

As an example, the features of the apparatus and valve of the invention may be associated in the following example claim combinations.

1. An apparatus for measuring a fluid, the apparatus comprising: a valve in communication with the fluid; and a transducer that measures the fluid; wherein: the transducer is mounted on the valve.

2. The apparatus of claim 1 further comprising a tank.

3. The apparatus of claim 2 wherein: the fluid is in the tank.

4. The apparatus of claim 2 wherein: the valve is attached to the tank.

5. The apparatus of claim 2 wherein: the valve controls flow of the fluid from the tank.

6. The apparatus of claim 2 wherein: the transducer is used to measure quantity of the fluid in the tank.

7. The apparatus of claim 2 wherein: the transducer is used to measure volume of the fluid in the tank.

8. The apparatus of claim 1 wherein: the transducer is a pressure transducer; and the transducer measures pressure of the fluid.

9. The apparatus of claim 1 wherein: the transducer is used to measure quantity of the fluid.

10. The apparatus of claim 1 wherein: the transducer is used to measure volume of the fluid.

11. The apparatus of claim 1 wherein the fluid is a liquid.

12. The apparatus of claim 1 wherein the fluid is milk.

13. The apparatus of claim 1 wherein the valve is a butterfly valve.

14. The apparatus of claim 1 wherein: the valve has an axis of rotation; and the transducer is mounted at the axis of rotation of the valve.

15. The apparatus of claim 1 wherein: the valve has an axis of rotation; and the transducer is parallel to the axis of rotation of the valve.

16. The apparatus of claim 1 wherein: the valve has an axis of rotation; and the transducer is concentric with the axis of rotation of the valve.

17. The apparatus of claim 1 wherein: the valve has an axis of rotation; and the axis of rotation is substantially vertical.

18. The apparatus of claim 1 wherein: the valve has an axis of rotation; and the axis of rotation is vertical.

19. The apparatus of claim 1 wherein: the valve has a bottom; and the transducer is mounted on the bottom of the valve.

20. The apparatus of claim 1 further comprising a pressure plate.

21. The apparatus of claim 1 further comprising a channel in the valve.

22. The apparatus of claim 1 further comprising a PLC that reads the transducer.

23. The apparatus of claim 1 further comprising a display that displays a quantity of the fluid.

24. A valve for controlling a fluid, the valve comprising a transducer mounted on the valve.

25. The valve of claim 24 wherein: the transducer is a pressure transducer; and the transducer measures pressure of the fluid.

26. The valve of claim 24 wherein: the transducer is used to measure quantity of the fluid.

27. The valve of claim 24 wherein: the transducer is used to measure volume of the fluid.

28. The valve of claim 24 wherein the fluid is a liquid.

29. The valve of claim 24 wherein the fluid is milk.

30. The valve of claim 24 wherein the valve is a butterfly valve.

31. The valve of claim 24 wherein: the valve has an axis of rotation; and the transducer is mounted at the axis of rotation of the valve.

32. The valve of claim 24 wherein: the valve has an axis of rotation; and the transducer is parallel to the axis of rotation of the valve.

33. The valve of any of the preceding claims wherein: the valve has an axis of rotation; and the transducer is concentric with the axis of rotation of the valve.

34. The valve of claim 24 wherein: the valve has an axis of rotation; and the axis of rotation is substantially vertical.

35. The valve of claim 24 wherein: the valve has an axis of rotation; and the axis of rotation is vertical.

36. The valve of claim 24 wherein: the valve has a bottom; and the transducer is mounted on the bottom of the valve.

37. The valve of claim 24 further comprising a pressure plate.

38. The valve of claim 24 further comprising a channel in the valve.

39. The valve of claim 24 further comprising a PLC that reads the transducer.

40. The valve of claim 24 further comprising a display that displays a quantity of the fluid.

41. An apparatus for storing and measuring milk, the apparatus comprising: a tank that holds the milk; a valve connected to the tank, wherein the valve controls flow of the milk from the tank; and a pressure transducer mounted on the valve; wherein: the pressure transducer measures pressure of the milk in the tank; and the pressure of the milk in the tank is used to calculate quantity of the milk in the tank.

42. The apparatus of claim 41 wherein the valve is a butterfly valve.

43. The apparatus of claim 41 wherein: the valve has an axis of rotation; and the transducer is mounted at the axis of rotation of the valve.

44. The apparatus of claim 14 wherein: the valve has an axis of rotation; and the transducer is parallel to the axis of rotation of the valve.

45. The apparatus of claim 41 wherein: the valve has an axis of rotation; and the transducer is concentric with the axis of rotation of the valve.

46. The apparatus of claim 14 wherein: the valve has an axis of rotation; and the axis of rotation is substantially vertical.

47. The apparatus of claim 41 wherein: the valve has an axis of rotation; and the axis of rotation is vertical.

48. The apparatus of claim 41 wherein: the valve has a bottom; and the transducer is mounted on the bottom of the valve.

49. The apparatus of claim 41 further comprising a pressure plate.

50. The apparatus of claim 49 wherein a cavity is machined into the valve and the pressure plate is located in the cavity.

51. The apparatus of claim 49 wherein the pressure plate and the valve are connected under vacuum.

52. The apparatus of claim 49 wherein the pressure plate and the transducer are connected under vacuum.

53. The apparatus of claim 49 further comprising a food-grade fluid wherein the pressure plate and the transducer are connected with the food-grade fluid.

54. The apparatus of claim 49 further comprising a channel in the valve.

55. The apparatus of claim 49 wherein: the pressure plate and the transducer are connected by a channel.

56. The apparatus of claim 55 wherein: the channel transmits pressure from the pressure plate to the transducer.

57. The apparatus of claim 54 wherein: the channel is machined into the valve.

58. The apparatus of claim 54 wherein: the channel extends through a component of the valve.

59. The apparatus of claim 41 further comprising a PLC that reads the transducer.

60. The apparatus of claim 59 wherein the PLC calculates a quantity of the fluid from a reading of the transducer.

61. The apparatus of claim 41 further comprising a display that displays a quantity of the fluid.

Various embodiments include an apparatus or method of obtaining or providing an apparatus or information, for instance, that include a novel combination of the features described herein. Even further, some embodiments include at least one means for accomplishing at least one functional aspect described herein. The subject matter described herein includes various means for accomplishing the various functions or acts described herein or that are apparent from the structure and acts described. Each function described herein is also contemplated as a means for accomplishing that function, or where appropriate, as a step for accomplishing that function. Moreover, various embodiments include certain (e.g., combinations of) aspects described herein. All novel combinations are potential embodiments. Some embodiments may include a subset of elements described herein and various embodiments include additional elements as well.

Further, various embodiments of the subject matter described herein include various combinations of the acts, structure, components, and features described herein, shown in the drawings, described in any documents that are incorporated by reference herein, or that are known in the art. Moreover, certain procedures can include acts such as manufacturing, obtaining, or providing components that perform functions described herein or in the documents that are incorporated by reference. Further, as used herein, the word “or”, except where indicated otherwise, does not imply that the alternatives listed are mutually exclusive. Even further, where alternatives are listed herein, it should be understood that in some embodiments, fewer alternatives may be available, or in particular embodiments, just one alternative may be available, as examples.

Although particular embodiments have been described herein, it will be appreciated that the invention is not limited thereto and that many modifications and additions thereto may be made within the scope of the invention. For example, various combinations of the features of the following dependent claims can be made with the features of the independent claims without departing from the scope of the present invention.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The term “at least” followed by a number is used herein to denote the start of a range beginning with that number (which may be a ranger having an upper limit or no upper limit, depending on the variable being defined). For example, “at least 1” means 1 or more than 1. The term “at most” followed by a number is used herein to denote the end of a range ending with that number (which may be a range having 1 or 0 as its lower limit, or a range having no lower limit, depending upon the variable being defined). For example, “at most 4” means 4 or less than 4, and “at most 40%” means 40% or less than 40%.

When, in this document, a range is given as “(a first number) to (a second number)” or “(a first number)−(a second number)”, this means a range whose lower limit is the first number and whose upper limit is the second number. For example, 25 to 100 should be interpreted to mean a range whose lower limit is 25 and whose upper limit is 100. Additionally, it should be noted that where a range is given, every possible subrange or interval within that range is also specifically intended unless the context indicates to the contrary. For example, if the specification indicates a range of 25 to 100 such range is also intended to include subranges such as 26-100, 27-100, etc., 25-99, 25-98, etc., as well as any other possible combination of lower and upper values within the stated range, e.g., 33-47, 60-97, 41-45, 28-96, etc. Note that integer range values have been used in this paragraph for purposes of illustration only and decimal and fractional values (e.g., 46.7-91.3) should also be understood to be intended as possible subrange endpoints unless specifically excluded.

It should be noted that where reference is made herein to a method comprising two or more defined steps, the defined steps can be carried out in any order or simultaneously (except where context excludes that possibility), and the method can also include one or more other steps which are carried out before any of the defined steps, between two of the defined steps, or after all of the defined steps (except where context excludes that possibility).

Further, it should be noted that terms of approximation (e.g., “about”, “substantially”, “approximately”, etc.) are to be interpreted according to their ordinary and customary meanings as used in the associated art unless indicated otherwise herein. Absent a specific definition within this disclosure, and absent ordinary and customary usage in the associated art, such terms should be interpreted to be plus or minus 10% of the base value.

Thus, the present invention is well adapted to carry out the objects and attain the ends and advantages mentioned above as well as those inherent therein. While the inventive device has been described and illustrated herein by reference to certain preferred embodiments in relation to the drawings attached thereto, various changes and further modifications, apart from those shown or suggested herein, may be made therein by those of ordinary skill in the art, without departing from the spirit of the inventive concept the scope of which is to be determined by the following claims.

What is claimed is:

1. An apparatus for measuring a fluid, the apparatus comprising:
a valve in communication with the fluid; and
a transducer that measures the fluid;
wherein: the transducer is mounted on the valve.

2. The apparatus of claim 1 further comprising a tank.

3. The apparatus of claim 2 wherein: the valve controls flow of the fluid from the tank.

4. The apparatus of claim 2 wherein: the transducer is used to measure quantity of the fluid in the tank.

5. The apparatus of claim 1 wherein: the transducer is a pressure transducer; and the transducer measures pressure of the fluid.

6. The apparatus of claim 1 wherein: the transducer is used to measure quantity of the fluid.

7. The apparatus of claim 1 wherein the fluid is milk.

8. The apparatus of claim 1 wherein the valve is a butterfly valve.

9. The apparatus of claim 1 wherein:
the valve has an axis of rotation; and
the transducer is mounted at the axis of rotation of the valve.

10. The apparatus of claim 1 wherein:
the valve has an axis of rotation; and
the transducer is parallel to the axis of rotation of the valve.

11. The apparatus of claim 1 wherein:
the valve has an axis of rotation; and
the transducer is concentric with the axis of rotation of the valve.

12. The apparatus of claim 1 wherein:
the valve has an axis of rotation; and
the axis of rotation is substantially vertical.

13. The apparatus of claim 1 wherein:
the valve has a bottom; and
the transducer is mounted on the bottom of the valve.

14. The apparatus of claim 1 further comprising a pressure plate.

15. The apparatus of claim 1 further comprising a channel in the valve.

16. The apparatus of claim 1 further comprising a PLC that reads the transducer.

17. The apparatus of claim 1 further comprising a display that displays a quantity of the fluid.

18. A valve for controlling a fluid, the valve comprising a transducer mounted on the valve.

19. The valve of claim 18 wherein:
the transducer is a pressure transducer; and
the transducer measures pressure of the fluid.

20. The valve of claim 18 wherein: the transducer is used to measure quantity of the fluid.
